(19) United States
(12) Patent Application Publication
(10) Pub. No.: US 2026/0135661 A1
(43) Pub. Date: May 14, 2026

(54) DMRS DESIGN FOR UPLINK IOT OVER NTN WITH OCC

(71) Applicant: QUALCOMM Incorporated, San Diego, CA (US)

(72) Inventors: Syed Hashim Ali SHAH, Cambridge, MA (US); Alberto RICO ALVARINO, San Diego, CA (US)

(21) Appl. No.: 19/295,382

(22) Filed: Aug. 8, 2025

Related U.S. Application Data
(60) Provisional application No. 63/718,522, filed on Nov. 8, 2024.

(51) Int. Cl. H04L 5/00; H04W 72/21

(52) U.S. Cl. CPC H04L 5/0051; H04W 72/21

(57) ABSTRACT

Apparatus, methods, and computer program products for wireless communication are provided. An example method may include receiving, from a network node, an orthogonal cover code (OCC) configuration for the UE. The example method may further include transmitting, to the network node, a demodulation reference signal (DM-RS), where the DM-RS is based on the OCC configuration.

### CROSS REFERENCE TO RELATED APPLICATION(S)

This application claims the benefit of and priority to U.S. Provisional Application Ser. No. 63/718,522, entitled “DMRS DESIGN FOR UPLINK IOT OVER NTN WITH OCC” and filed on Nov. 8, 2024, which is expressly incorporated by reference herein in its entirety.

### TECHNICAL FIELD

The present disclosure relates generally to communication systems, and more particularly, to wireless communication systems with orthogonal cover code (OCC).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to (e.g., cause the UE to) receive, from a network node, an orthogonal cover code (OCC) configuration for the UE. Based at least in part on information stored in the at least one memory, the at least one processor, individually or in any combination, is configured to transmit, to the network node, a demodulation reference signal (DM-RS), where the DM-RS is based on the OCC configuration.

In another aspect of the disclosure, a method, a computer-readable medium, and an apparatus at a UE are provided. The apparatus may include at least one memory and at least one processor coupled to the at least one memory. Based at least in part on information stored in the at least one memory, the at least one processor, individually or in any combination, is configured to (e.g., cause the UE to) transmit, to a network node, a demodulation reference signal (DM-RS), where a scrambling sequence of the DM-RS is based on a cell identifier associated with the network node and an absolute transmission time associated with the transmission of the DM-RS. Based at least in part on information stored in the at least one memory, the at least one processor, individually or in any combination, is configured to transmit, to the network node, at least one narrow band physical uplink shared channel (NPUSCH) transmission.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4 is a diagram illustrating an example of orthogonal cover code (OCC) for two UEs, in accordance with various aspects of the present disclosure.

FIG. 5 is a diagram illustrating example demodulation reference signal (DM-RS), in accordance with various aspects of the present disclosure.

FIG. 6 is a diagram illustrating example DM-RS for two different UEs, in accordance with various aspects of the present disclosure.

FIG. 7 is a diagram illustrating example DM-RS for two UEs that adds OCC, in accordance with various aspects of the present disclosure.

FIG. 8 is a diagram illustrating example DM-RS repetition for two UEs that adds OCC, in accordance with various aspects of the present disclosure.

FIG. 9 is a diagram illustrating another example DM-RS repetition for two UEs that adds OCC, in accordance with various aspects of the present disclosure.

FIG. 10 is a diagram illustrating example DM-RS repetition for two UEs that is based on a gold sequence, in accordance with various aspects of the present disclosure.

FIG. 11 is a diagram illustrating example DM-RS without repetition for two UEs that adds OCC, in accordance with various aspects of the present disclosure.

FIG. 12 is a diagram illustrating example communications between a network node and a UE, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a diagram illustrating an example of a hardware implementation for an example apparatus and/or network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Aspects provided herein introduce a robust demodulation reference signal (DM-RS) design to support these systems with orthogonal cover code (OCC) that prevents degradation in channel estimation performance and related performance degradation. Aspects provided herein provide DM-RS designs that uses OCC on top of a default DM-RS pattern without OCC to support narrowband physical uplink shared channel (NPUSCH) with OCC over narrowband Internet of Things (IoT) (NB-IoT) non-terrestrial network (NTN). Aspects provided herein may also enable scrambling for UL DM-RS over NB-IoT NTN systems which use OCC for NPUSCH.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer). While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

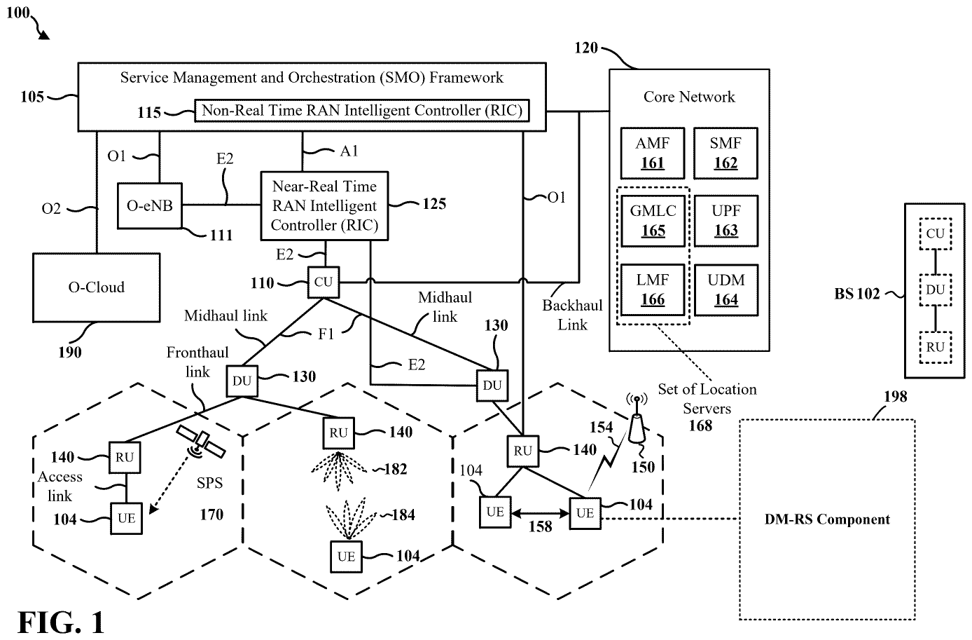

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a DM-RS component 198. In some aspects, the DM-RS component 198 may be configured to receive, from a network node, an orthogonal cover code (OCC) configuration for the UE. In some aspects, the DM-RS component 198 may be configured to transmit, to the network node, a demodulation reference signal (DM-RS), where the DM-RS is based on the OCC configuration.

In some aspects, the DM-RS component 198 may be configured to transmit, to a network node, a demodulation reference signal (DM-RS), where a scrambling sequence of the DM-RS is based on a cell identifier associated with the network node and an absolute transmission time associated with the transmission of the DM-RS. In some aspects, the DM-RS component 198 may be configured to transmit, to the network node, at least one narrow band physical uplink shared channel (NPUSCH) transmission.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

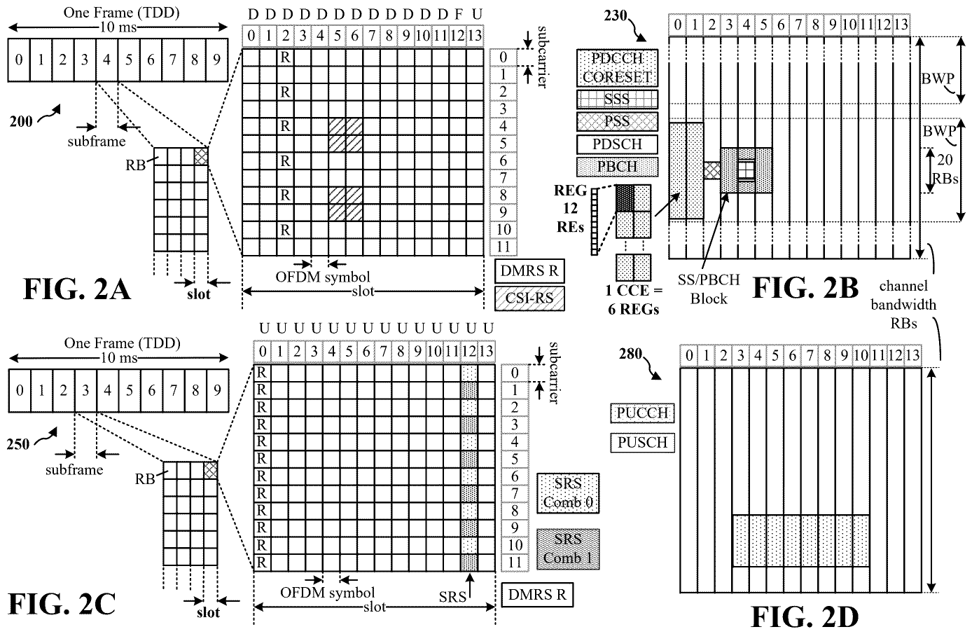

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

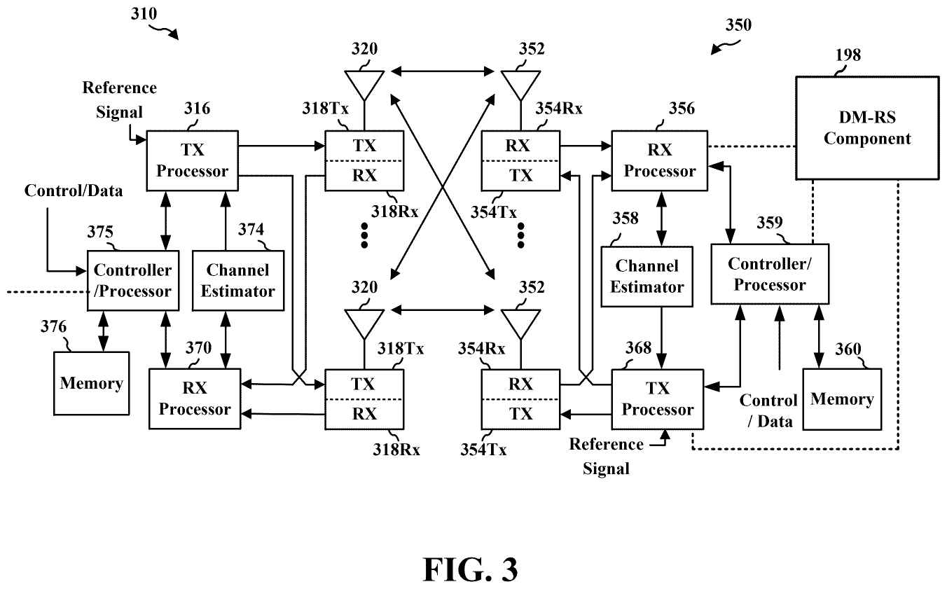

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with DM-RS component 198 of FIG. 1.

Multiple access schemes may be used to multiplex multiple UEs, hence increasing capacity (e.g., serving more UEs in a same amount of time-frequency resources). Multiplexing multiple UEs may create interference at the base station. Orthogonal cover codes (OCC) may mitigate such interference. By utilizing OCCs, which may be orthogonal and nullify interference when different codes are assigned to different UEs, multiple UEs may be able to communicate with a same network node simultaneously on the same time/frequency resources without causing interference. OCCs may serve as spreading codes, spreading each user's signal across a wider unit of time, frequency or both. The network node may separate the signals from multiple UEs by assigning different UEs with different specific OCCs (different codewords) in a OCC configuration. In a OCC configuration, an OCC factor and an OCC index may be included, where the OCC factor is greater than or equal to a quantity of UEs associated with multiplex based on the OCC configuration and the OCC index may be specifically assigned differently for each UE. The OCC index may correspond to an orthogonal codeword. The data from UEs may be cover coded across repetitions in an orthogonal manner using an OCC. The repetition nature of uplink transmissions may result in that systems may do OCC for a low cost. OCC can increase duration of transmitted signals by a multiplexing factor of M, where M is the number of UEs multiplexed and may be smaller than or equal to the OCC factor.

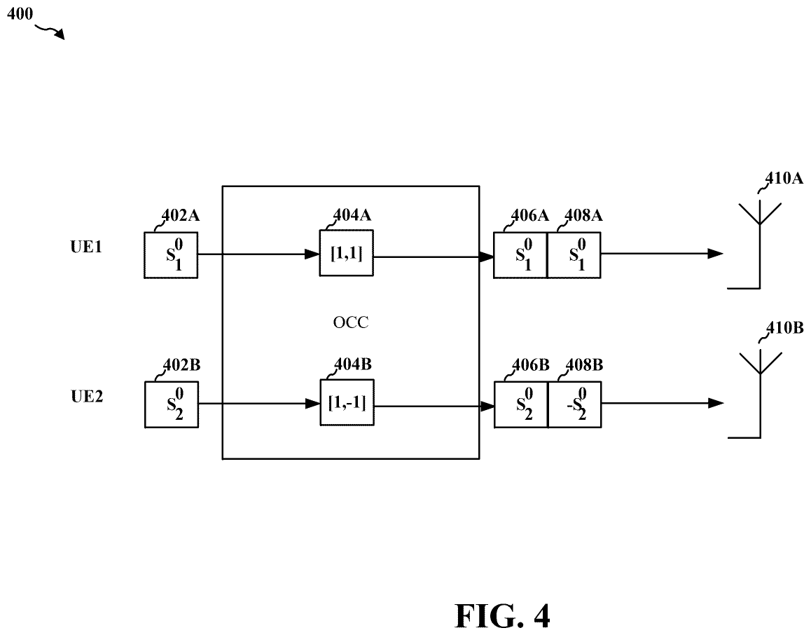

FIG. 4 is a diagram 400 illustrating an example of OCC for two UEs, in accordance with various aspects of the present disclosure.

$${s}_{i}^{j}$$

may denote RE j at UE i. As illustrated in FIG. 4, with a OCC factor of 2, for a first UE,

$${s}_{1}^{0} 402 A$$

may be based [1,1] 404A, which is orthogonal with [1,−1] 404B of

$${s}_{2}^{0} 402 B$$

for a second UE. Based on [1,1],

$${s}_{1}^{0}$$

may be spread into

$${s}_{1}^{0} 406 A and {s}_{1}^{0} 408 A ,$$

may be transmitted based on antenna 410A. Based on [1,−1],

$${s}_{2}^{0}$$

may be spread into

$${s}_{2}^{0} 406 B - {s}_{1}^{0} 480 B ,$$

which may be transmitted based on antenna 410B. Therefore, these spread entitles on each UE are orthogonal to each other.

OCC may be used or NPUSCH capacity enhancement, for example, enhancements to enable multiplexing of multiple UEs (e.g. up to the min of 2 and the maximum allowed by the existing UL and DL signalling) in a single 3.75 kHz or 15 kHz subcarrier via orthogonal cover codes (OCC) for NPUSCH format 1 and NPRACH may be enabled. NPUSCH format 1 may be used for carrying uplink user data in narrowband Internet of Things (IoT) (NB-IoT), which is designed for low-power, wide-area connectivity for IoT devices. The transmission uses a single subcarrier out of a limited number (usually 12 or 48 subcarriers in a 180 kHz bandwidth channel). NPRACH may be narrowband PRACH that is used by NB-IoT devices for random access procedures, enabling a device to initiate communication with the network. NPRACH may use frequency hopping across different subcarriers within the 180 kHz channel bandwidth and supports repeated transmission of preambles.

Therefore, OCC may be used in the context of NB-IoT non-terrestrial network (NTN) with UL capacity enhancements. OCC may be used for NPUSCH over NB-IoT NTN because UL transmissions generally include multiple repetitions to enhance coverage. Multiple repetitions would result in low operating effective channel coding rates. Because of high number of repetitions and low coding rate, the network may support more UEs in the same amount of repetitions using OCC without significant performance loss. Aspects provided herein introduce a robust DMRS design to support these systems with OCC that prevents degradation in channel estimation performance and related performance degradation. Aspects provided herein provide DM-RS designs that uses OCC on top of a default DM-RS pattern without OCC (which may be referred to as “legacy DM-RS pattern”) to support NPUSCH with OCC over NB-IoT NTN. Aspects provided herein may also enable scrambling for UL DM-RS over NB-IoT NTN systems which use OCC for NPUSCH.

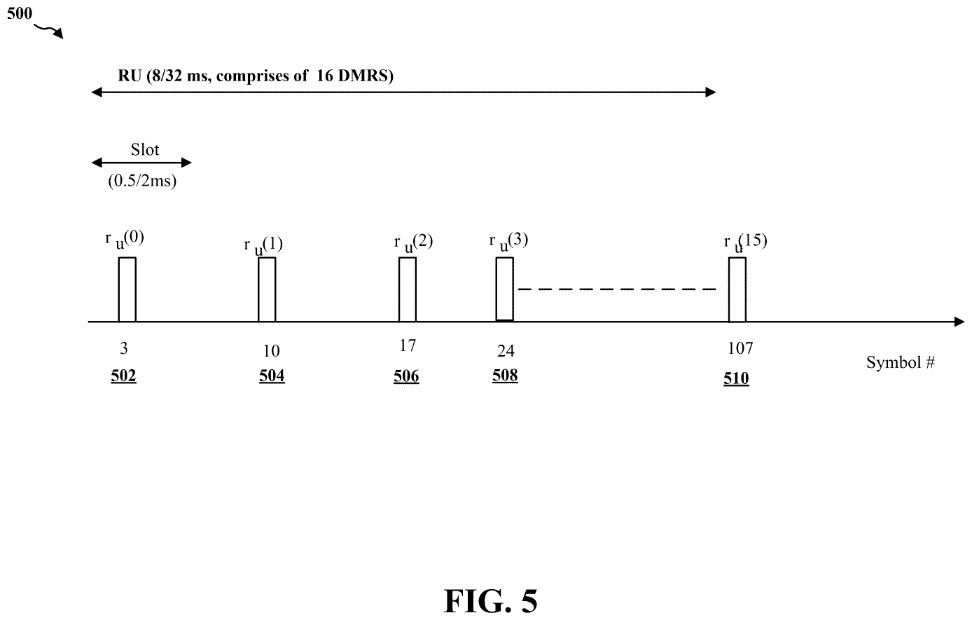

FIG. 5 is a diagram 500 illustrating example legacy DM-RS, in accordance with various aspects of the present disclosure. For uplink NB-IoT single sub-carrier (N_{sc}^{RU}=1) case, DM-RS may occur every 7 symbols (every slot). One resource unit (RU) may have 16 slots, resulting a total of 16 DM-RS symbols. Duration of 1 slot is 0.5 ms for 15 kHz SCS, 2 ms for 3.75 kHz SCS. Duration of 1 RU is 8 ms for 15 kHz, 32 ms for 3.75 kHz. A legacy DM-RS pattern may be a gold sequence combined with a length 16 Hadamard (OCC) sequence. The Hadamard sequence is orthogonal amongst cells, i.e., UEs using different cells may use orthogonal Hadamard sequences (the overall sequence will be orthogonal if the gold sequence is the same). As illustrated in FIG. 5, for 15 kHz SCS, a first DM-RS symbol at symbol 3 502 may be denoted by rᵤ(0), a second DM-RS symbol at symbol 10 504 may be denoted by rᵤ(1), a third DM-RS symbol at symbol 17 506 may be denoted by rᵤ(2), a fourth DM-RS symbol at symbol 24 508 may be denoted by rᵤ(3), and a sixteenth DM-RS symbol at symbol 107 510 may be denoted by rᵤ(15).

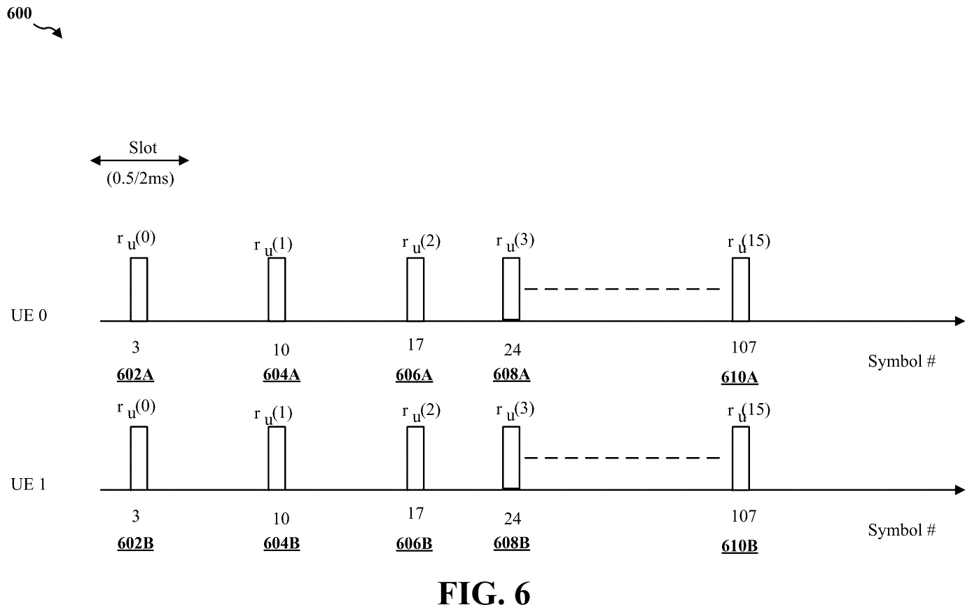

If UE 1 and UE2 are being served by the same cell (for NTN, a cell may be a satellite beam in this case), the DM-RS transmitted by UE 1 and 2 may not be orthogonal. At the receiver (network), there may be interference caused by both DM-RS if the transmissions are aligned in time. Such interference may lead to degradation in channel estimation which may in turn impact performance of data (NPUSCH) being orthogonally cover coded (OCC'ed), and compromising capacity gains offered by OCC. Similarly, interference may also mean that impairments like carrier frequency offset (CFO) may not be correctly estimated using DM-RS. Systems with OCC may be sensitive to phase impairments like CFO, and bad estimation of CFO may also lead to performance degradation of NPUSCH capacity. FIG. 6 is a diagram 600 illustrating example DM-RS for two different UEs, in accordance with various aspects of the present disclosure. As illustrated in FIG. 6, for a first UE, a first DM-RS symbol at symbol 3 602A may be denoted by rᵤ(0), a second DM-RS symbol at symbol 10 604A may be denoted by rᵤ(1), a third DM-RS symbol at symbol 17 606A may be denoted by rᵤ(2), a fourth DM-RS symbol at symbol 24 608A may be denoted by rᵤ(3), and a sixteenth DM-RS symbol at symbol 107 610A may be denoted by rᵤ(15). For a second UE, the DM-RS may be the same where a first DM-RS symbol at symbol 3 602B may be denoted by rᵤ(0), a second DM-RS symbol at symbol 10 604B may be denoted by rᵤ(1), a third DM-RS symbol at symbol 17 606B may be denoted by rᵤ(2), a fourth DM-RS symbol at symbol 24 608B may be denoted by rᵤ(3), and a sixteenth DM-RS symbol at symbol 107 610B may be denoted by rᵤ(15). Therefore, to mitigate the impact of this interference, aspects provided herein may provide DM-RS patterns where OCC may be done in the DM-RS for NPUSCH (within each cell).

In some aspects, OCC may be added on top of DM-RS. Let

$${s}_{u}^{m} ( n )$$

be the transmitted DM-RS symbol at slot number n, cell (beam) u (u=N^{cell}_{ID} mod 16) and UE m, let OCC factor (which may be greater than or equal to the multiplexing order or quantity of UEs multiplexed, and may represent the maximum amount of supported UEs to be multiplexed) be M, and rᵤ(n) be the legacy DM-RS symbol at slot number n, cell (beam) u, for all indices start from 0, OCC in DM-RS may be provided based on the formula below:

$${s}_{u}^{m} ( n ) = {r}_{u} ( ⌊ \frac{n}{M} ⌋ ) H ( m , mod [ n , M ] ) , where$$

$$0 \leq n \leq {M}_{rep}^{pusch} {N}_{slots}^{U L} {N}_{RU}$$

The parameter

$${M}_{r e p}^{pusch} {N}_{slots}^{U L} {N}_{R U}$$

is the total number of slots for NPUSCH transmission. Depending on how the RU to OCC is defined, the parameter may be modified with

$${M}_{r e p}^{pusch} {N}_{slots}^{U L} {N}_{R U} M ,$$

where M is the OCC factor. The parameter m=0, . . . , M−1 is the OCC codeword index (otherwise referred to as “OCC index” or “OCC codeword”) assigned to the UE (e.g., row/column of an orthogonal matrix). m may be assigned to the UE by NW via radio resource control (RRC) or downlink control information (DCI) (the UE may be aware of m based on network signaling of OCC configuration). The parameter H is the orthogonal matrix/sequence used for OCC (e.g., Hadamard, DFT, Welsh, or the like). The parameter

$${s}_{u}^{m} ( n )$$

may be the final OCC'ed DM-RS to be transmitted by the UE. The network may have to receive at least M DM-RS to start undoing the OCC of (de-OCCing) DM-RS and start channel estimation, and such de-OCCing may aid in mitigating interference in DM-RS due to multiplexing because orthogonality may be introduced due to OCC'ed transmissions. Such a design may introduce randomization across UEs in the same cell if they start at different times, and ensures at least pseudo random interference cancellation across cells and may provide orthogonal interference cancellation. In some aspects, the

$${r}_{u} ( ⌊ \frac{n}{M} ⌋ )$$

portion may be modified based on

$${r}_{u} ( M ⌊ \frac{n}{M} ⌋ ) ,$$

where one out of every M samples may be skipped.

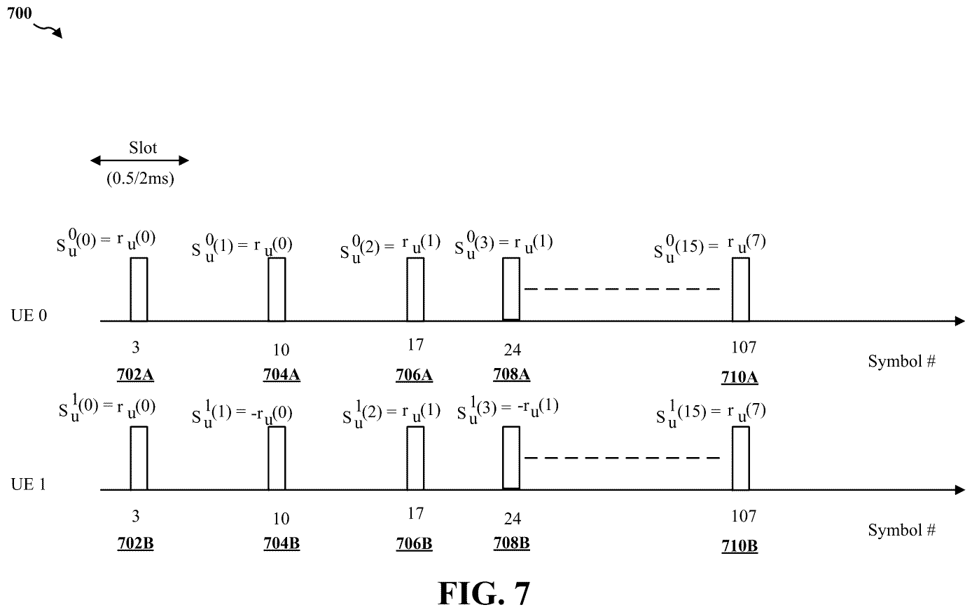

FIG. 7 is a diagram 700 illustrating example DM-RS for two UEs that adds OCC, in accordance with various aspects of the present disclosure. For the example in FIG. 7, the legacy NPUSCH may DM-RS be based on rᵤ(n)=x[n] wᵤ(n mod 16), where

$$0 \leq n \leq {M}_{rep}^{pusch} {N}_{slots}^{U L} {N}_{RU} and$$

$$x [ n ] = \frac{1}{√ 2} ( 1 + j ) ( 1 - 2 c [ n ] ) .$$

The H matrix may be

$$( \begin{matrix}1 & 1 \\ 1 & - 1\end{matrix} ) .$$

As illustrated in FIG. 7, for a first UE, a first DM-RS symbol at symbol 3 702A may be rᵤ(0), a second DM-RS symbol at symbol 10 704A may be rᵤ(0), a third DM-RS symbol at symbol 17 706A may be rᵤ(1), a fourth DM-RS symbol at symbol 24 708A may be rᵤ(1), and a sixteenth DM-RS symbol at symbol 107 710A may be rᵤ(7). For a second UE, a first DM-RS symbol at symbol 3 702B may be rᵤ(0), a second DM-RS symbol at symbol 10 704B may be −rᵤ(0), a third DM-RS symbol at symbol 17 706B may be rᵤ(1), a fourth DM-RS symbol at symbol 24 708B may be −rᵤ(1), and a sixteenth DM-RS symbol at symbol 107 710B may be −rᵤ(7). At the receiver, the network may observe see y[n] given channel hₘ[n] for UE m with noise w as the following: y[0]=(h₁+h₂)rᵤ[0]+w, y[1]=(h₁−h₂)rᵤ[0]+w, y[2]=(h₁+h₂)rᵤ[1]+w, y[3]=(h₁−h₂)rᵤ[1]+w. Because the network knows rᵤ[n] and receives y[n], the network can estimate channel hₘ[n].

In some aspects, OCC may be added on top of DM-RS with repetition. In such aspects, the legacy DM-RS pattern, which may be a base sequence, may be modified based on the formula below:

$${r}_{u} ( n ) = x [ n ] {w}_{u} ( n mod 16 ) , where 0 \leq n \leq {M}_{rep}^{pusch} {N}_{slots}^{UL} {N}_{RU} and$$

$$x [ n ] = \frac{1}{√ 2} ( 1 + j ) ( 1 - 2 c [ n ] )$$

Let

$${s}_{u}^{m} ( n )$$

be the transmitted DM-RS symbol at slot number n, cell (beam) u and UE m. Let OCC factor be M. The transmitted DM-RS symbol

$${s}_{u}^{m} ( n )$$

may be based on the formula below:

$${s}_{u}^{m} ( n ) = x [ ⌊ \frac{n}{M} ⌋ ] {w}_{( u + m ) mod 16} [ n mod 16 ] or$$

$${s}_{u}^{m} ( n ) = x [ ⌊ \frac{n}{M} ⌋ ] {w}_{( u - m ) mod 16} [ n mod 16 ] where$$

$$0 \leq n \leq {M}_{rep}^{pusch} {N}_{slots}^{UL} {N}_{RU} and 0 \leq m \leq M - 1$$

The parameter m=0, . . . , M−1 is the OCC codeword index assigned to the UE. The parameter sᵤ^{m}(n) is the final OCC'ed DM-RS to be transmitted. The NW may have to receive at least M DM-RS to start de-OCCing the DM-RS and start channel estimation. The de-OCCing may aid in mitigating interference in DM-RS due to multiplexing because orthogonality may be introduced due to OCC'ed transmissions. Such a scheme may ensure at least pseudo random interference cancellation across cells and may enable orthogonal interference cancellation. In some aspects, the

$${r}_{u} ( ⌊ \frac{n}{M} ⌋ )$$

portion may be modified based on

$${r}_{u} ( M ⌊ \frac{n}{M} ⌋ ) ,$$

where one out of every M samples may be skipped. In some aspects, alternatively, the index of w can be indicated by the network per OCC index, e.g. instead of w_{(u+m)mod 16}, w_{ƒ(m)} may be used, with ƒ(m) as a function of the OCC codeword index. The function may be a mapping table indicated by the network in, by way of example, RRC or SIB, or may be hardcoded without network signaling. Additionally, the function ƒ(m) may be time varying and changing across groups of M-slots/RUs/multiple RU.

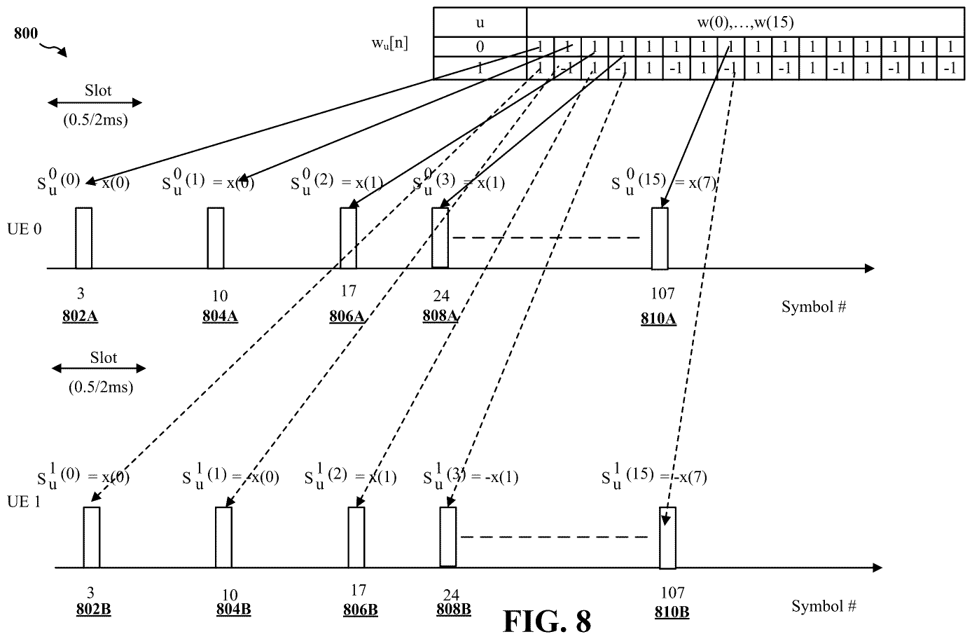

FIG. 8 is a diagram 800 illustrating example DM-RS repetition for two UEs that adds OCC, in accordance with various aspects of the present disclosure. As illustrated in FIG. 8, for a first UE, a first DM-RS symbol at symbol 3 802A may be x(0), a second DM-RS symbol at symbol 10 804A may be x(0), a third DM-RS symbol at symbol 17 806A may be x(1), a fourth DM-RS symbol at symbol 24 808A may be x(1), and a sixteenth DM-RS symbol at symbol 107 810A may be x(7). For a second UE, a first DM-RS symbol at symbol 3 802B may be x(0), a second DM-RS symbol at symbol 10 804B may be −x(0), a third DM-RS symbol at symbol 17 806B may be x(1), a fourth DM-RS symbol at symbol 24 808B may be −x(1), and a sixteenth DM-RS symbol at symbol 107 810B may be −x(7).

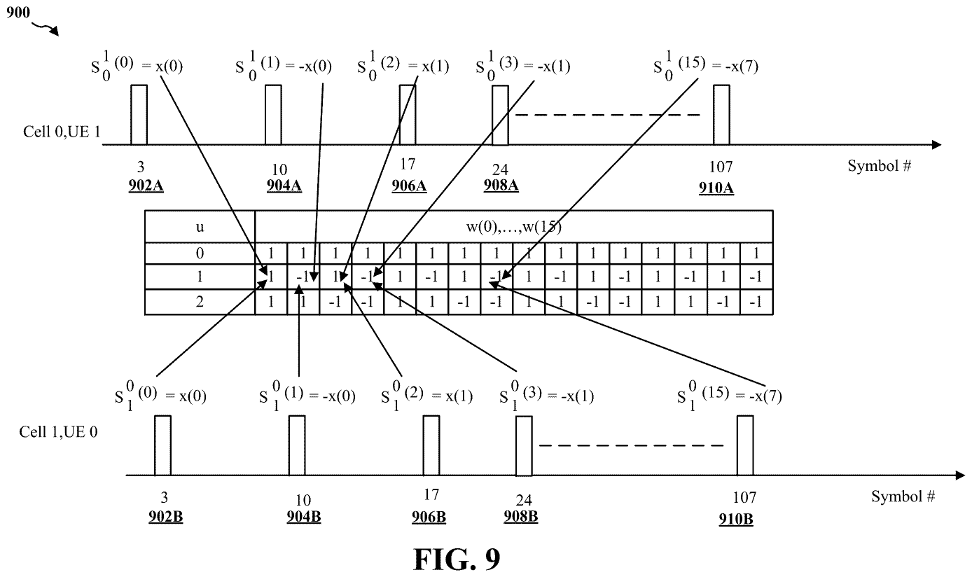

In another example, when there are two cells (u=0 and u=1) using OCC, FIG. 9 is a diagram 900 illustrating another example DM-RS repetition for two UEs that adds OCC, in accordance with various aspects of the present disclosure. As illustrated in FIG. 9, for a first UE, a first DM-RS symbol at symbol 3 902A may be x(0), a second DM-RS symbol at symbol 10 904A may be −x(0), a third DM-RS symbol at symbol 17 906A may be x(1), a fourth DM-RS symbol at symbol 24 908A may be −x(1), and a sixteenth DM-RS symbol at symbol 107 910A may be −x(7). For a second UE, a first DM-RS symbol at symbol 3 902B may be x(0), a second DM-RS symbol at symbol 10 904B may be −x(0), a third DM-RS symbol at symbol 17 906B may be x(1), a fourth DM-RS symbol at symbol 24 908B may be −x(1), and a sixteenth DM-RS symbol at symbol 107 910B may be −x(7).

If the transmissions are aligned for both UEs in the cells, the UEs may end up sending the same signal, therefore they completely interfere with each other (they aren't orthogonal neither pseudorandom).

Let rᵤ(n) be the transmitted legacy DM-RS symbol at slot number n, cell (beam) u (no UE index here since no OCC) (u=N^{cell}_{ID} mod 16), assuming all indices start from 0, the transmitted legacy DM-RS symbol rᵤ(n) may be provided based on the formula below:

$${r}_{u} ( n ) = \frac{1}{√ 2} ( 1 + j ) ( 1 - 2 c [ n ] ) {w}_{u} ( n mod 16 ) , where 0 \leq n \leq {M}_{rep}^{pusch} {N}_{slots}^{UL} {N}_{RU}$$

The parameter c[n] is gold sequence generated based on slot number n. The parameter wᵤ(n) is an entry taken from a defined 16×16 Hadamard matrix. Gold sequences may be pseudo-random sequences that can help in interference mitigation (by scrambling). The sequences may become uncorrelated if they are misaligned, or they are generated using different initial conditions (denoted by cᵢₙᵢₜ) In some communication systems, cᵢₙᵢₜ may be fixed to 35. Therefore, all the UEs transmitting to all cells may have same gold sequences generated at a given slot (since sequence value depends on slot index −c[n] and not on cell value). If multiple UEs are using the same cell, the chances that their transmissions are aligned may be very low, hence the gold sequences for the multiple UEs using same cells are uncorrelated helping in interference mitigation. In some aspects, to further mitigate potential interference, the gold sequence may be based on cell identifier and an absolute transmission time.

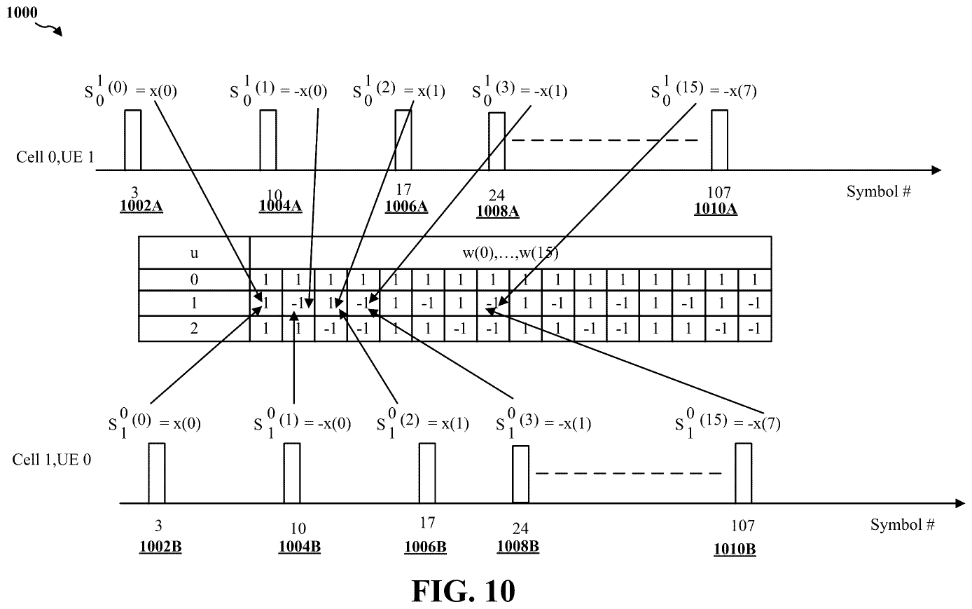

FIG. 10 is a diagram 1000 illustrating example DM-RS repetition for two UEs that is based on a gold sequence, in accordance with various aspects of the present disclosure. As illustrated in FIG. 10, for a first UE, a first DM-RS symbol at symbol 3 1002A may be x(0), a second DM-RS symbol at symbol 10 1004A may be −x(0), a third DM-RS symbol at symbol 17 1006A may be x(1), a fourth DM-RS symbol at symbol 24 1008A may be −x(1), and a sixteenth DM-RS symbol at symbol 107 1010A may be −x(7). For a second UE, a first DM-RS symbol at symbol 3 1002B may be x(0), a second DM-RS symbol at symbol 10 1004B may be −x(0), a third DM-RS symbol at symbol 17 1006B may be x(1), a fourth DM-RS symbol at symbol 24 1008B may be −x(1), and a sixteenth DM-RS symbol at symbol 107 1010B may be −x(7). If the gold sequence used for scrambling are dependent on cell ID, then signals from two cells may be pseudorandom. Therefore, for systems with OCC, in some aspects, generation (e.g., initialization) of gold sequence may be based on cell ID. In some aspects, the gold sequence when being initialized may also depend on the absolute transmission unit (system frame number (SFN), frame number, or the like). Therefore, two UEs with different starting absolute times will have different sequences and hence will be uncorrelated. So even though UEs may start transmission at a same time, the absolute time may make them uncorrelated. Therefore, the gold sequence may also be a function of cell ID and starting absolute time units. In some aspects, cᵢₙᵢₜ may be configured to be dependent on cell ID, slot number, SFN, frame number, C-RNTI, other RNTI, or the like. To generate the gold sequence, cᵢₙᵢₜ and a length of sequence based on total number of slots

$$( {M}_{r e p}^{p u s c h} {N}_{slots}^{UL} {N}_{R U} )$$

may be used to generate c[n].

In some aspects, OCC may be added on top of DM-RS without repetition. Let rᵤ(n) be the transmitted legacy DM-RS symbol at slot number n, cell (beam) u (no UE index here since no OCC) (u=N^{cell}_{ID} mod 16), assuming all indices start from 0, rᵤ(n) may be based on the formula below:

$${r}_{u} ( n ) = \frac{1}{√ 2} ( 1 + j ) ( 1 - 2 c [ n ] ) {w}_{u} ( n mod 16 ) , where 0 \leq n \leq {M}_{rep}^{pusch} {N}_{slots}^{UL} {N}_{RU}$$

c[n] is gold sequence generated based on slot number n. wᵤ(n) is an entry taken from a defined Hadamard matrix. In some aspects, rᵤ(n) may also be based on the formula below:

$${r}_{u} ( n + k 0 ) = x [ n + k 0 ] {w}_{u} ( n mod 16 ) , where 0 \leq n \leq {M}_{rep}^{pusch} {N}_{slots}^{UL} {N}_{RU} and$$

$$x [ n ] = \frac{1}{√ 2} ( 1 + j ) ( 1 - 2 c [ n ] )$$

The parameter x[n] is the final scrambling sequence. The scrambling sequence x is the same for a given absolute slot across all UEs, regardless of what is the starting slot (k0) of the NPUSCH transmission (i.e., now the sequence is defined in an absolute slot not a relative slot, and the gold sequence is initialized at SFN0/SF0).

In some aspects, let

$${s}_{u}^{m} ( n )$$

be the transmitted DM-RS symbol at slot number n, cell (beam) u and UE m. Let OCC factor (multiplexing order or # of UEs multiplexed) be M, the

$${s}_{u}^{m} ( n )$$

may be provided based on the formula below:

$${s}_{u}^{m} ( n + {k}_{0} ) = x [ n + {k}_{0} ] {w}_{( u + m ) mod 16} [ n ] or$$

$${s}_{u}^{m} ( n + {k}_{0} ) = x [ n + {k}_{0} ] {w}_{( u - m ) mod 16} [ n ] where$$

$$0 \leq n \leq {M}_{rep}^{pusch} {N}_{slots}^{UL} {N}_{RU} and 0 \leq m \leq M - 1$$

The parameter m=0, . . . , M−1 is the OCC codeword index assigned to the UE by the network.

$${s}_{u}^{m} ( n )$$

may denote the final orthogonal DM-RS to be transmitted. The NW may have to receive at least M DM-RS to start channel estimation.

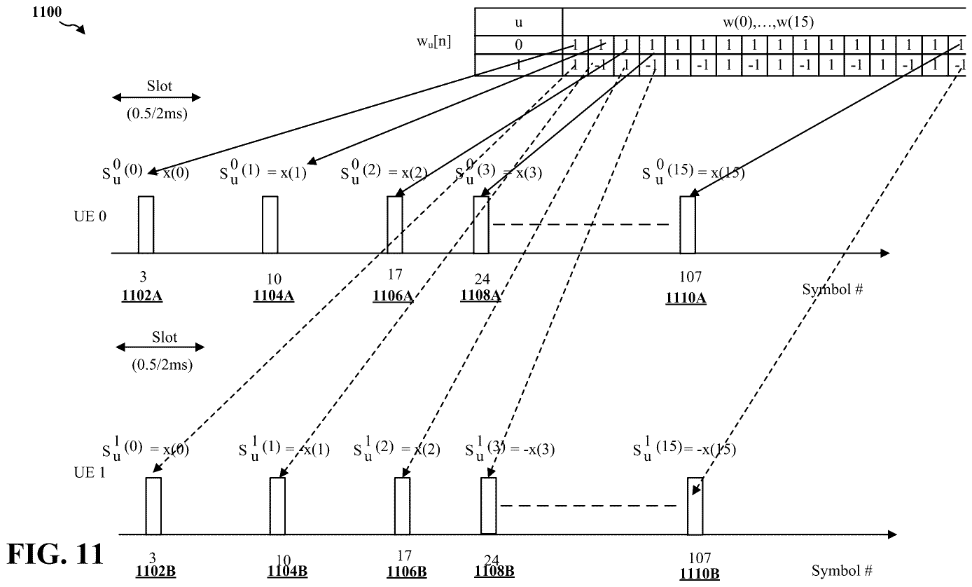

FIG. 11 is a diagram 1100 illustrating example DM-RS without repetition for two UEs that adds OCC, in accordance with various aspects of the present disclosure. As illustrated in FIG. 11, for a first UE, a first DM-RS symbol at symbol 3 1102A may be x(0), a second DM-RS symbol at symbol 10 1104A may be x(1), a third DM-RS symbol at symbol 17 1106A may be x(2), a fourth DM-RS symbol at symbol 24 1108A may be x(3), and a sixteenth DM-RS symbol at symbol 107 1110A may be x(15). For a second UE, a first DM-RS symbol at symbol 3 1102B may be x(0), a second DM-RS symbol at symbol 10 1104B may be −x(1), a third DM-RS symbol at symbol 17 1106B may be x(2), a fourth DM-RS symbol at symbol 24 1108B may be −x(3), and a sixteenth DM-RS symbol at symbol 107 1110B may be −x(15).

At the receiver, the network may observe y[n] given channel hₘ[n] for UE m with noise w where y[0]=(h₁+h₂)x[0]+w, y[1]=(h₁−h₂)x[1]+n, y[2]=(h₁+h₂)x[2]+w, y[3]=(h₁−h₂)x[3]+w. Because the network may be aware of x[n] and receives y[n], it may estimate channel hm [n].

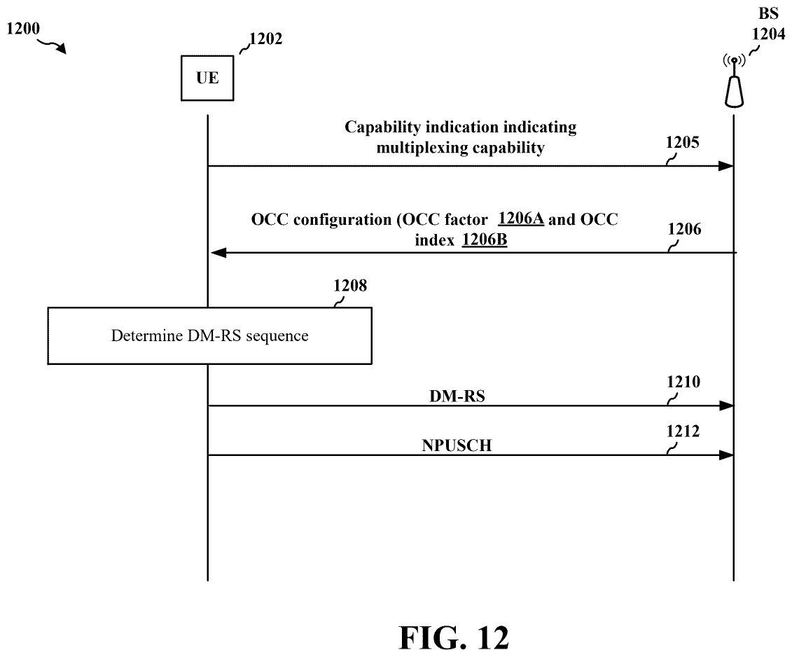

FIG. 12 is a diagram 1200 illustrating example communications between a network node 1204 and a UE 1202, in accordance with various aspects of the present disclosure. As illustrated in FIG. 12, the UE 1202 may transmit capability indication 1205 indicating capability for multiplexing. The capability for multiplexing may depend on the phase coherence capabilities associated with the UE 1202. Based on the capability to support multiplexing, the network node 1204 may configure, via RRC, DCI, or medium access control (MAC) control element (MAC-CE), a OCC configuration 1206 with OCC factor 1206A and OCC index 1206B. In some aspects, the OCC configuration 1206 may also indicate the scheme (e.g., according to aspects described in connection with one of FIG. 7 to FIG. 11) to be used by the UE 1202 to determine the DM-RS sequence at 1208. The UE 1202 may transmit UL DM-RS 1210 to the network node 1204 and also transmit NPUSCH transmission 1212 to the network node 1204.

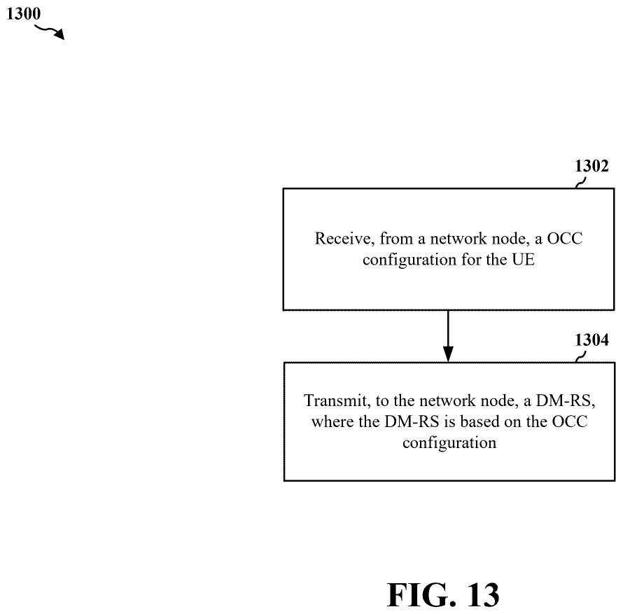

FIG. 13 is a flowchart 1300 of a method of wireless communication. The method may be performed by a UE (e.g., the UE 104, the UE 1202; the apparatus 1504). Aspects provided herein introduce a robust DMRS design to support these systems with OCC that prevents degradation in channel estimation performance and related performance degradation. Aspects provided herein provide DM-RS designs that uses OCC on top of a default DM-RS pattern without OCC (which may be referred to as “legacy DM-RS pattern”) to support NPUSCH with OCC over NB-IoT NTN. Aspects provided herein may also enable scrambling for UL DM-RS over NB-IoT NTN systems which use OCC for NPUSCH.

At 1302, the UE may receive, from a network node, a OCC configuration for the UE. For example, the UE 1202 may receive, from a network node 1204, a OCC configuration (e.g., 1206) for the UE. In some aspects, 1302 may be performed by DM-RS component 198. In some aspects, the OCC configuration includes an OCC factor (e.g., 1206A) and an OCC index (e.g., 1206B), where the OCC factor is greater than or equal to a quantity of UEs associated with multiplex based on the OCC configuration.

At 1304, the UE may transmit, to the network node, a DM-RS, where the DM-RS is based on the OCC configuration. For example, the UE 1202 may transmit, to the network node, a DM-RS, where the DM-RS is based on the OCC configuration. In some aspects, 1304 may be performed by DM-RS component 198.

In some aspects, a symbol of the DM-RS at a particular slot is based on the OCC configuration, a slot number of the particular slot, the OCC index, and the OCC factor. As a particular example, in some aspects (e.g., FIG. 7), the symbol of the DM-RS at a particular slot is based on an orthogonal matrix associated with the OCC configuration, a slot number of the particular slot, the OCC index, and the OCC factor. In some aspects, the orthogonal matrix is represented by H (m, mod [n, M]), where H is the orthogonal matrix, m is the OCC index, n is the slot number, and M is the OCC factor.

In some aspects (e.g., FIG. 8 or FIG. 9), a symbol of the DM-RS at a particular slot is based on a series of base sequence associated with the DM-RS, a slot number of the particular slot, and the OCC factor, and where an index of the base sequence is based on the OCC index. In some aspects, the index of the base sequence is based on a modulo of the OCC index and a particular number. In some aspects, the index of the base sequence is based on a function of the OCC index. In some aspects, the symbol of the DM-RS is associated with more than one repetition.

In some aspects (e.g., FIG. 11), a symbol of the DM-RS at a particular slot is based on a series of base sequence associated with the DM-RS, a slot number of the particular slot, a gold sequence based on the slot number of the particular slot, the OCC index, and the OCC factor. In some aspects, the DM-RS symbol is further based on an absolute slot across all UEs in the quantity of UEs.

In some aspects, the UE may transmit, to the network node, a capability indication (e.g., 1205) that indicates a multiplexing capability at the UE and receive, from the network node, the OCC configuration (e.g., 1206) based on the capability that indicates the multiplexing capability at the UE.

In some aspects, the UE may receive, from the network node, a DM-RS configuration associated with the UE that configures the UE to configure DM-RS based on a particular formula from a series of formulas.

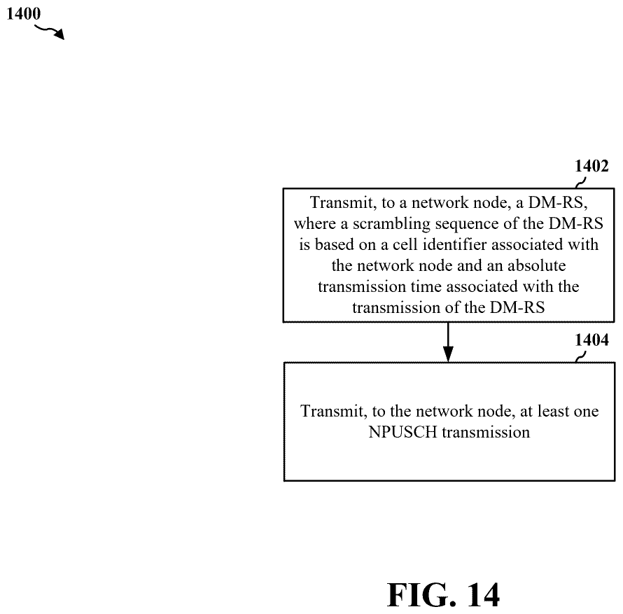

FIG. 14 is a flowchart 1400 of a method of wireless communication. The method may be performed by a UE (e.g., the UE 104, the UE 1202; the apparatus 1504). Aspects provided herein introduce a robust DMRS design to support these systems with OCC that prevents degradation in channel estimation performance and related performance degradation. Aspects provided herein provide DM-RS designs that uses OCC on top of a default DM-RS pattern without OCC (which may be referred to as “legacy DM-RS pattern”) to support NPUSCH with OCC over NB-IoT NTN. Aspects provided herein may also enable scrambling for UL DM-RS over NB-IoT NTN systems which use OCC for NPUSCH.

At 1402, the UE may transmit, to a network node, a DM-RS, where a scrambling sequence of the DM-RS is based on a cell identifier associated with the network node and an absolute transmission time associated with the transmission of the DM-RS. For example, the UE 1202 may transmit, to a network node 1204, a DM-RS (e.g., 1210), where a scrambling sequence of the DM-RS (e.g., in FIG. 10) is based on a cell identifier associated with the network node and an absolute transmission time associated with the transmission of the DM-RS. In some aspects, 1402 may be performed by DM-RS component 198. In some aspects, the scrambling sequence is initialized based on the absolute transmission time. In some aspects, the absolute transmission time is a system frame number (SFN) associated with the DM-RS. In some aspects, the absolute transmission time is a slot number associated with the DM-RS. In some aspects, the scrambling sequence may be a gold sequence and may be initialized additionally based on a radio network temporary identifier (RNTI) associated with the UE. In some aspects, the gold sequence is initialized additionally based on a cell-radio network temporary identifier (C-RNTI) associated with the UE. In some aspects, the scrambling sequence is based on a gold sequence. In some aspects, the UE is a narrowband Internet of Things (IoT) UE.

At 1404, the UE may transmit, to the network node, at least one NPUSCH transmission. For example, the UE 1202 may transmit, to the network node 1204, at least one NPUSCH transmission (e.g., 1212). In some aspects, 1404 may be performed by DM-RS component 198.

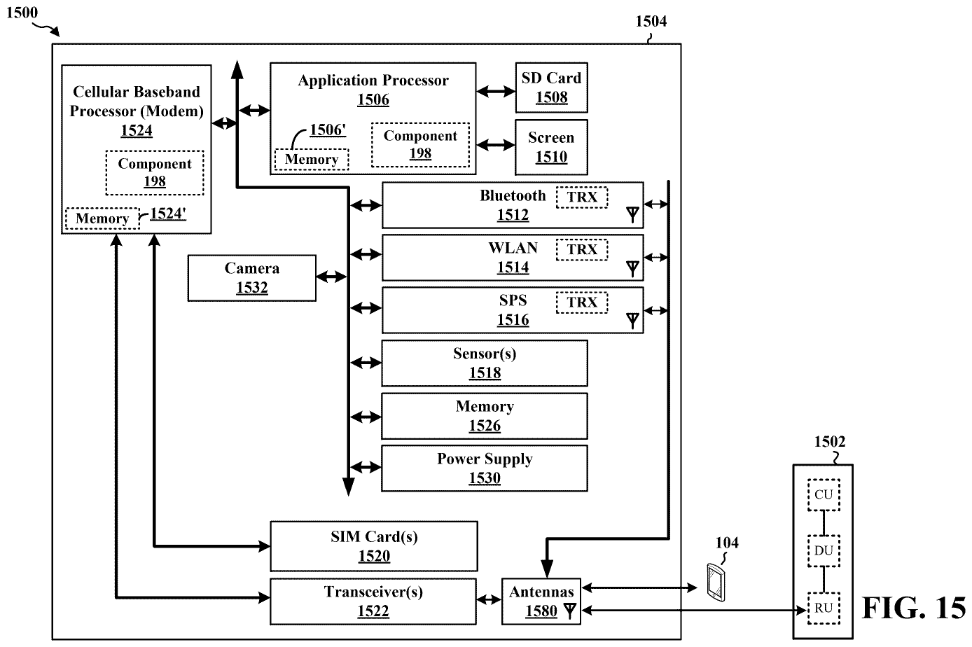

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) 1524 communicates through the transceiver(s) 1522 via one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the DM-RS component 198 may be configured to receive, from a network node, an orthogonal cover code (OCC) configuration for the UE. In some aspects, the DM-RS component 198 may be configured to transmit, to the network node, a demodulation reference signal (DM-RS), where the DM-RS is based on the OCC configuration.

In some aspects, the DM-RS component 198 may be configured to transmit, to a network node, a demodulation reference signal (DM-RS), where a scrambling sequence of the DM-RS is based on a cell identifier associated with the network node and an absolute transmission time associated with the transmission of the DM-RS. In some aspects, the DM-RS component 198 may be configured to transmit, to the network node, at least one narrow band physical uplink shared channel (NPUSCH) transmission. The DM-RS component 198 may be within the cellular baseband processor(s) 1524, the application processor(s) 1506, or both the cellular baseband processor(s) 1524 and the application processor(s) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for receiving, from a network node, an orthogonal cover code (OCC) configuration for the UE. In some aspects, the apparatus 1504 may include means for transmitting, to the network node, a demodulation reference signal (DM-RS), where the DM-RS is based on the OCC configuration. In some aspects, the apparatus 1504 may include means for transmitting, to the network node, a capability indication that indicates a multiplexing capability at the UE. In some aspects, the apparatus 1504 may include means for receiving, from the network node, the OCC configuration based on the capability that indicates the multiplexing capability at the UE. In some aspects, the apparatus 1504 may include means for receiving, from the network node, a DM-RS configuration associated with the UE that configures the UE to configure DM-RS based on a particular formula from a series of formulas. In some aspects, the apparatus 1504 may include means for transmitting, to a network node, a demodulation reference signal (DM-RS), where a scrambling sequence of the DM-RS is based on a cell identifier associated with the network node and an absolute transmission time associated with the transmission of the DM-RS. In some aspects, the apparatus 1504 may include means for transmitting, to the network node, at least one narrow band physical uplink shared channel (NPUSCH) transmission. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a user equipment (UE), including: at least one memory; and at least one processor coupled to the at least one memory, and based at least in part on information stored in the at least one memory, the at least one processor, individually or in any combination, is configured to cause the UE to: receive, from a network node, an orthogonal cover code (OCC) configuration for the UE; and transmit, to the network node, a demodulation reference signal (DM-RS), where the DM-RS is based on the OCC configuration.

Aspect 2 is the apparatus of aspect 1, where the OCC configuration includes an OCC factor and an OCC index, where the OCC factor is greater than or equal to a quantity of UEs associated with multiplexing based on the OCC configuration.

Aspect 3 is the apparatus of aspect 2, where a symbol of the DM-RS at a particular slot is based on the OCC configuration, a slot number of the particular slot, the OCC index, and the OCC factor.

Aspect 4 is the apparatus of aspect 3, where the symbol is further based on an orthogonal matrix represented by H (m, mod [n, M]), where H is the orthogonal matrix, m is the OCC index, n is the slot number, and M is the OCC factor (e.g., H is an orthogonal matrix with dimensions M×M, the entry to be accessed for DMRS symbol transmission may be accessed by via row entry m and column entry mod(n,M) of H, or by via row entry mod(n,M) and column entry m).

Aspect 5 is the apparatus of any of aspects 2-4, where a symbol of the DM-RS at a particular slot is based on a series of base sequence associated with the DM-RS, a slot number of the particular slot, and the OCC factor, and where an index of the base sequence is based on the OCC index.

Aspect 6 is the apparatus of aspect 5, where the index of the base sequence is based on a modulo of the OCC index and a particular number.

Aspect 7 is the apparatus of any of aspects 5-6, where the index of the base sequence is based on a function of the OCC index.

Aspect 8 is the apparatus of any of aspects 5-7, where the symbol of the DM-RS is associated with more than one repetition.

Aspect 9 is the apparatus of any of aspects 2-8, where a symbol of the DM-RS at a particular slot is based on a series of base sequence associated with the DM-RS, a slot number of the particular slot, a gold sequence based on the slot number of the particular slot, the OCC index, and the OCC factor.

Aspect 10 is the apparatus of aspect 9, where the DM-RS symbol is further based on an absolute slot across all UEs in the quantity of UEs.

Aspect 11 is the apparatus of any of aspects 1-10, where the at least one processor, individually or in any combination, is further configured to cause the UE to: transmit, to the network node, a capability indication that indicates a multiplexing capability at the UE; and receive, from the network node, the OCC configuration based on the capability that indicates the multiplexing capability at the UE.

Aspect 12 is the apparatus of any of aspects 1-11, where the at least one processor, individually or in any combination, is further configured to cause the UE to: receive, from the network node, a DM-RS configuration associated with the UE that configures the UE to configure DM-RS based on a particular formula from a series of formulas.

Aspect 13 is an apparatus for wireless communication at a user equipment (UE), including: at least one memory; and at least one processor coupled to the at least one memory, and based at least in part on information stored in the at least one memory, the at least one processor, individually or in any combination, is configured to cause the UE to: transmit, to a network node, a demodulation reference signal (DM-RS), where a scrambling sequence of the DM-RS is based on a cell identifier associated with the network node and an absolute transmission time associated with the transmission of the DM-RS; and transmit, to the network node, at least one narrow band physical uplink shared channel (NPUSCH) transmission.

Aspect 14 is the apparatus of aspect 13, where the scrambling sequence is initialized based on the absolute transmission time.

Aspect 15 is the apparatus of aspect 14, where the absolute transmission time is a system frame number (SFN) associated with the DM-RS.

Aspect 16 is the apparatus of aspect 14, where the absolute transmission time is a slot number associated with the DM-RS.

Aspect 17 is the apparatus of any of aspects 14-16, where the scrambling sequence is initialized additionally based on a radio network temporary identifier (RNTI) associated with the UE.

Aspect 18 is the apparatus of any of aspects 14-17, where the scrambling sequence is initialized additionally based on a cell-radio network temporary identifier (C-RNTI) associated with the UE.

Aspect 19 is the apparatus of any of aspects 13-18, where the scrambling sequence is based on a gold sequence

Aspect 20 is the apparatus of any of aspects 13-19, where the UE is a narrow band Internet of things (NB-IoT) UE and the network node is a non-terrestrial network (NTN) network node.

Aspect 21 is a method of wireless communication for implementing any of aspects 1 to 20.

Aspect 22 is a computer-readable medium (e.g., a non-transitory computer-readable medium) storing computer executable code, the code when executed by at least one processor causes the at least one processor to implement any of aspects 1 to 20.

Aspect 23 is an apparatus comprising means for implementing any of aspects 1 to 20.

What is claimed is:

1. An apparatus for wireless communication at a user equipment (UE), comprising:
at least one memory; and
at least one processor coupled to the at least one memory, and based at least in part on information stored in the at least one memory, the at least one processor is configured to:
receive, from a network node, an orthogonal cover code (OCC) configuration for the UE; and
transmit, to the network node, a demodulation reference signal (DM-RS), wherein the DM-RS is based on the OCC configuration.

2. The apparatus of claim 1, wherein the OCC configuration comprises an OCC factor and an OCC index, wherein the OCC factor is greater than or equal to a quantity of UEs associated with multiplexing based on the OCC configuration.

3. The apparatus of claim 2, wherein a symbol of the DM-RS at a particular slot is based on the OCC configuration, a slot number of the particular slot, the OCC index, and the OCC factor.

4. The apparatus of claim 2, wherein a symbol of the DM-RS at a particular slot is based on a series of base sequence associated with the DM-RS, a slot number of the particular slot, and the OCC factor, and wherein an index of the base sequence is based on the OCC index.

5. The apparatus of claim 4, wherein the index of the base sequence is based on a modulo of the OCC index and a particular number.

6. The apparatus of claim 4, wherein the index of the base sequence is based on a function of the OCC index.

7. The apparatus of claim 4, wherein the symbol of the DM-RS is associated with more than one repetition.

8. The apparatus of claim 2, wherein a symbol of the DM-RS at a particular slot is based on a series of base sequence associated with the DM-RS, a slot number of the particular slot, a gold sequence based on the slot number of the particular slot, the OCC index, and the OCC factor.

9. The apparatus of claim 8, wherein the DM-RS symbol is further based on an absolute slot across all UEs in the quantity of UEs.

10. The apparatus of claim 1, wherein the at least one processor is further configured to:
transmit, to the network node, a capability indication that indicates a multiplexing capability at the UE; and
receive, from the network node, the OCC configuration based on the capability that indicates the multiplexing capability at the UE.

11. The apparatus of claim 1, wherein the at least one processor is further configured to:
receive, from the network node, a DM-RS configuration associated with the UE that configures the UE to configure DM-RS based on a particular formula from a series of formulas.

12. An apparatus for wireless communication at a user equipment (UE), comprising:
at least one memory; and
at least one processor coupled to the at least one memory, and based at least in part on information stored in the at least one memory, the at least one processor is configured to:
transmit, to a network node, a demodulation reference signal (DM-RS), wherein a scrambling sequence of the DM-RS is based on a cell identifier associated with the network node and an absolute transmission time associated with the transmission of the DM-RS; and
transmit, to the network node, at least one narrow band physical uplink shared channel (NPUSCH) transmission.

13. The apparatus of claim 12, wherein the scrambling sequence is initialized based on the absolute transmission time.

14. The apparatus of claim 13, wherein the absolute transmission time is a system frame number (SFN) associated with the DM-RS.

15. The apparatus of claim 13, wherein the absolute transmission time is a slot number associated with the DM-RS.

16. The apparatus of claim 13, wherein the scrambling sequence is initialized additionally based on a radio network temporary identifier (RNTI) associated with the UE.

17. The apparatus of claim 13, wherein the scrambling sequence is initialized additionally based on a cell-radio network temporary identifier (C-RNTI) associated with the UE.

18. The apparatus of claim 12, wherein the scrambling sequence is based on a gold sequence.

19. The apparatus of claim 12, wherein the UE is a narrow band Internet of things (NB-IoT) UE and the network node is a non-terrestrial network (NTN) network node.

20. A method for wireless communication performed by a user equipment (UE), comprising:
receiving, from a network node, an orthogonal cover code (OCC) configuration for the UE, wherein the OCC configuration comprises an OCC factor and an OCC index, and wherein the OCC factor is greater than or equal to a quantity of UEs associated with multiplexing based on the OCC configuration; and
transmitting, to the network node, a demodulation reference signal (DM-RS), wherein the DM-RS is based on the OCC configuration, wherein a symbol of the DM-RS at a particular slot is based on the OCC configuration, a slot number of the particular slot, the OCC index, and the OCC factor.
